(19) United States
(12) Patent Application Publication
(10) Pub. No.: US 2012/0027427 A1
(43) Pub. Date: Feb. 2, 2012

(54) SHEET FINISHER, IMAGE FORMING APPARATUS AND SHEET FINISHING METHOD

(75) Inventor: Hiroyuki TAKI, Shizuoka-ken (JP)

(73) Assignees: Toshiba Tec Kabushiki Kaisha, Tokyo (JP); Kabushiki Kaisha Toshiba, Tokyo (JP)

(21) Appl. No.: 13/191,126

(22) Filed: Jul. 26, 2011

Related U.S. Application Data
(60) Provisional application No. 61/368,625, filed on Jul. 28, 2010.

(51) Int. Cl. G03G 15/00; B31F 5/00; B31F 1/08; B65H 7/06

(52) U.S. Cl. 399/21; 270/45; 399/363

(57) ABSTRACT

A sheet finisher according to an embodiment includes: a fold roller which folds a central area of a sheet bundle to form a fold line on the sheet bundle; a fold reinforcing roller which moves along a direction of the fold line while pressing the fold line of the sheet bundle to reinforce the fold line; and a drive unit which includes a motor and transmits a drive torque of the motor to the fold reinforcing roller, so that the drive torque can be changed, to move the fold reinforcing roller along the fold line.

### CROSS-REFERENCE TO RELATED APPLICATIONS

This application is based upon and claims the benefit of priority from: U.S. provisional application 61/368,625 filed on Jul. 28, 2010, the entire contents of which are incorporated herein by reference.

### FIELD

Embodiments described herein relate generally to a sheet finisher, an image forming apparatus, and a sheet finishing method.

### BACKGROUND

In the related art, there is known a sheet finisher which is disposed downstream of an image forming apparatus such as a copier, a printer or an MFP (Multi-Functional Peripheral), and performs a finishing process such as a punching process or a stitching process for a printed sheet.

Recently, as the function of this sheet finisher is diversified, a sheet finisher is proposed which has, in addition to the function of the punching process and the stitching process, the function of a folding process to fold a part of a sheet or the function of a saddle-stitching and folding process to staple the central area of a sheet and then to fold the sheet at the central area.

In the sheet finisher having the function of the saddle-stitching and folding process, it becomes possible to form a booklet (to bind a book) from a plurality of printed sheets.

In the saddle-stitching and folding process proposed in the related art, after the central area of sheets is stitched with staples or the like, a process is performed for forming a fold line on the stitched part by a pair of rollers called fold rollers and for forming folding. At this time, a plate-like member called a fold blade is brought into contact with the stitched part of the sheet bundle, and is pressed into a nip section of the fold roller pair to form the fold line on the sheet bundle.

However, since the time when the folded part of the sheet bundle is pressed by the nip section of the fold rollers is short, and the whole folded part is simultaneously pressed by the nip section of the fold rollers, the pressure is dispersed to the whole fold line. Thus, the fold line formed by the fold rollers becomes such a fold line that the pressure is not sufficiently applied thereto. Particularly, in a case where the number of sheets is large, or in a case where a thick sheet is contained in the sheet bundle, the fold line often becomes incomplete.

In order to deal with this problem, there is proposed a fold line reinforcing device in which the fold line pushed out of the fold rollers is inserted into a nip section of a pair of fold reinforcing rollers and the fold line is reinforced by moving the pair of fold reinforcing rollers along the fold line.

The movement direction of the fold reinforcing rollers is a direction that is orthogonal to a transport direction of the sheet bundle. Thus, if a sheet jam occurs due to any cause during movement of the fold reinforcing rollers, it is difficult to deal with this problem. Even though a user desires to pull out the sheet bundle along the transport direction, since the transport direction of the sheet bundle and the rotation direction of the fold reinforcing rollers are perpendicular each other, it is difficult to smoothly pull out the sheet bundle.

Upon the occurrence of the sheet jam, there is proposed such a technique that an alarm is displayed or the fold reinforcing rollers return to a home position. However, with this technique, the whole apparatus should be temporarily stopped. Thus, the booklet forming efficiency is lowered. In addition, a user is forced to extra work for removing the sheet bundle from the apparatus.

Accordingly, it is desirable to provide a sheet finisher, an image forming apparatus and a sheet finishing method which can effectively reduce the possibility that the apparatus is temporarily stopped due to a sheet jam.

### DESCRIPTION OF THE DRAWINGS

FIG. 1 is a perspective view showing an outer appearance example of an image forming apparatus according to an exemplary embodiment;

FIG. 2 is a sectional view showing a configuration example of the image forming apparatus;

FIG. 3 is a sectional view showing a configuration example of a saddle stitch processing unit;

FIG. 4 is a perspective outer appearance view showing the whole structure of a fold reinforcing unit;

FIGS. 5A and 5B are schematic sectional views for mainly illustrating a structure of a support section;

FIG. 6 is a perspective outer appearance view showing a structural example of a roller unit;

FIG. 7 is a view of the fold reinforcing unit seen from a transport destination of a sheet bundle;

FIG. 8 is a first view illustrating a mechanism of up-and-down driving of an upper roller;

FIG. 9 is a second view illustrating the mechanism;

FIG. 10 is a diagram showing a detailed configuration example of a drive unit;

FIG. 11 is a diagram illustrating a switch mechanism of torque of the drive unit;

FIG. 12 is a flowchart illustrating an example of an operation when a sheet jam occurs in a sheet finisher according to the exemplary embodiment;

FIG. 13 is a diagram illustrating a switching operation of a drive torque when the sheet jam occurs and an operation of the fold reinforcing roller thereafter; and

FIG. 14 is a flowchart illustrating an example of the switching operation according the number of sheets of the sheet bundle or the presence or absence of a thick sheet.

### DETAILED DESCRIPTION

An embodiment of a sheet finisher and an image forming apparatus will be described with reference to the accompanying drawings.

The sheet finisher according to an embodiment includes: a fold roller which folds a central area of a sheet bundle to form a fold line on the sheet bundle; a fold reinforcing roller which moves along a direction of the fold line while pressing the fold line of the sheet bundle to reinforce the fold line; and a drive unit which includes a motor and transmits a drive torque of the motor to the fold reinforcing roller, so that the drive torque can be changed, to move the fold reinforcing roller along the fold line.

### (1) Configuration

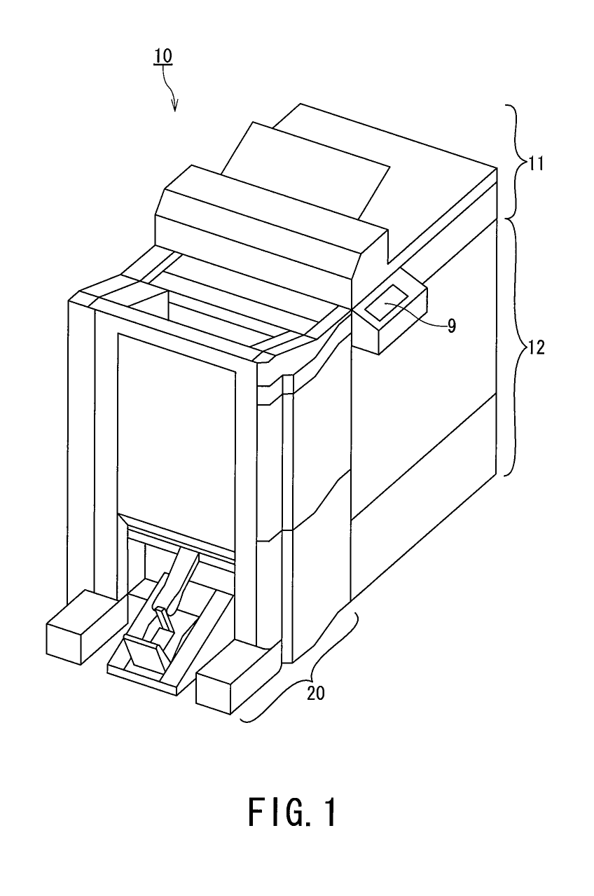

FIG. 1 is an outer appearance perspective view showing a basic configuration example of an image forming apparatus 10 according to an embodiment. The image forming apparatus 10 includes a read unit 11 which reads an original document, an image forming unit 12 which prints image data on the read original document to a sheet by an electro-photographic technique, and a sheet finisher 20 which performs a finishing process such as a sorting process, a punching process, a folding process or a saddle stitching process, for the printed sheet. Further, the image forming unit 12 is provided with an operation unit 9 by which a user performs various operations.

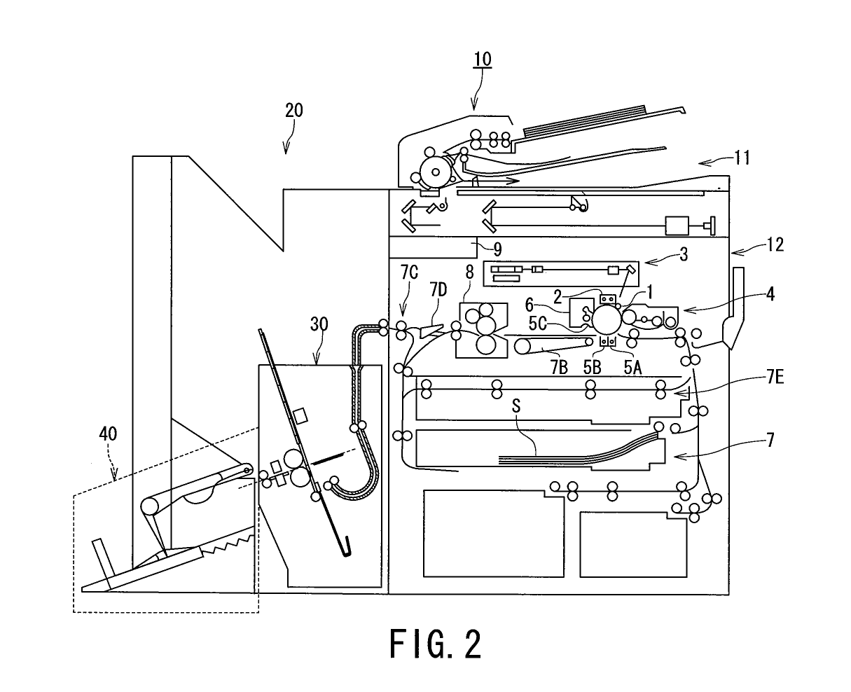

FIG. 2 is a sectional view showing a detailed configuration example of the image forming apparatus 10.

The image forming unit 12 of the image forming apparatus 10 includes a photoconductive drum 1 in the vicinity of the central area thereof, and a charging unit 2, an exposing unit 3, a developing unit 4, a transfer unit 5A, a charge removing unit 5B, a separating pawl 5C, and a cleaning unit 6 are respectively disposed around the photoconductive drum 1. Further, a fixing unit 8 is provided on a downstream side of the charge removing unit 5B. An image forming process is performed by these units roughly in the following procedure.

First, a surface of the photoconductive drum 1 is uniformly charged by the charging unit 2. On the other hand, an original document read by the read unit 11 is converted into image data, and is input to the exposing unit 3. In the exposing unit 3, a laser beam corresponding to the level of the image data irradiates the photoconductive drum 1, and an electrostatic latent image is formed on the photoconductive drum 1. The electrostatic latent image is developed with a toner supplied from the developing unit 4, and thus a toner image is formed on the photoconductive drum 1.

On the other hand, a sheet contained in a sheet containing unit 7 is transported to a transfer position (gap between the photoconductive drum 1 and the transfer unit 5A) through some transport rollers. At the transfer position, the toner image is transferred from the photoconductive drum 1 to the sheet by the transfer unit 5A. Electric charges on the surface of the sheet on which the toner image is transferred are erased by the charge removing unit 5B, and are separated from the photoconductive drum 1 by the separating pawl 5C. Thereafter, the sheet is transported by an intermediate transport section 7B, and is heated and pressed by the fixing unit 8, so that the toner image is fixed to the sheet. The sheet on which the fixing process is completed is discharged from a discharge section 7C and is output to the sheet finisher 20.

The developer remaining on the surface of the photoconductive drum 1 is removed by the cleaning unit 6 on the downstream side of the separating pawl 5C, and is ready for the next image formation.

When duplex printing is performed, the sheet on the surface of which the toner image is fixed is branched from a normal discharge path by a transport path switching plate 7D, is switched back in a reversal transport section 7E to be turned upside down. A print process similar to one-side printing is performed on the back side of the reversed sheet, and then the sheet is output from the discharge section 7C to the sheet finisher 20.

The sheet finisher 20 includes a saddle stitch processing unit 30 and a sheet bundle placement section 40 in addition to a sorter section (not shown) which sorts the sheets.

The saddle stitch processing unit 30 performs a process (saddle stitch process) for stitching a central area of a plurality of printed sheets discharged from the image forming unit 12 with staples and performing folding, so as to form a booklet.

The booklet saddle-stitched by the saddle stitch processing unit 30 is output to the sheet bundle placement section 40, and the bound booklet is finally placed thereon.

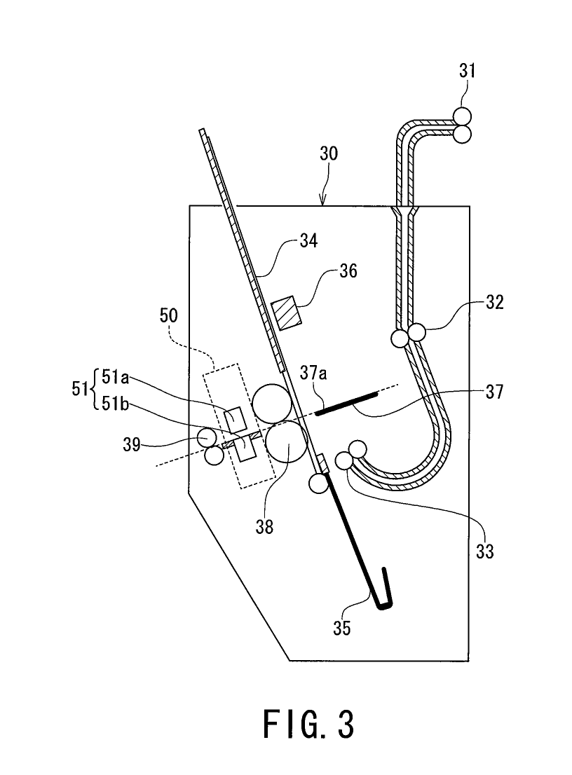

FIG. 3 is a sectional view showing a detailed configuration example of the saddle stitch processing unit 30.

In the saddle stitch processing unit 30, the sheet discharged from the discharge section 7C of the image forming unit 12 is received by an inlet roller pair 31 and is delivered to an intermediate roller pair 32. The intermediate roller pair 32 delivers the sheet to an outlet roller pair 33. The outlet roller pair 33 sends the sheet to a standing tray 34 having an inclined placement surface. The leading edge of the sheet is directed toward an upper part of the inclination of the standing tray 34.

A stacker 35 is provided below the standing tray 34, and receives the lower edge of the sheet which is switched back and falls from the upper part of the inclination of the standing tray 34.

A stapler 36 is provided at the middle of the standing tray 34. When the saddle stitch process (stapling) is performed on the sheet bundle, the position of the stacker 35 is adjusted so that the position of the sheet bundle to be stapled (a central area of the sheet bundle in the up-and-down direction) faces the stapler 36.

When the sheet bundle is stapled by the stapler 36, the stacker 35 descends until the position of the sheet bundle where a fold line is to be formed (the central area of the sheet bundle in the up-and-down direction and the position where the staples are inserted) comes to the front of a fold blade 37.

When the position where the fold line is to be formed comes to the front of the fold blade 37, a leading edge 37a of the fold blade 37 pushes a surface which becomes an inner surface after the sheet bundle is folded.

A fold roller pair 38 is provided ahead of the fold blade 37 in a traveling direction. The sheet bundle pushed by the fold blade 37 slides into a nip section of the fold roller pair 38, and the fold line is formed at the central area of the sheet bundle.

The sheet bundle on which the fold line is formed by the fold roller pair 38 is transported to a fold reinforcing unit 50 provided on the downstream side thereof. The sheet bundle transported to the fold reinforcing unit 50 is temporarily stopped there.

The fold reinforcing unit 50 is provided with a fold reinforcing roller pair 51 which includes an upper roller 51a and a lower roller 51b. The fold reinforcing roller pair 51 moves in a direction (direction along the fold line) orthogonal to the transport direction of the sheet bundle while pressing the fold line, to reinforce the fold line.

The sheet bundle whose fold line is reinforced by the fold reinforcing unit 50 again starts to be transported, is pulled by an discharge roller pair 39 and is output to the sheet bundle placement section 40, and the sheet bundle (booklet) which is saddle-stitched is placed on the sheet bundle placement section 40.

### (2) Structure and Operation of Fold Reinforcing Unit

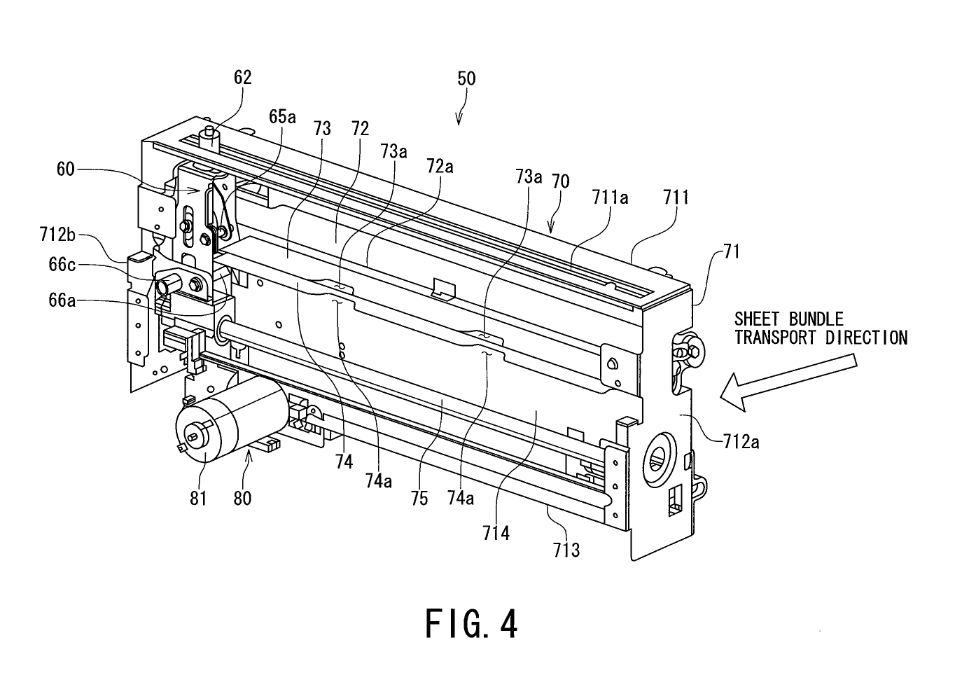

FIG. 4 is a perspective outer appearance view showing the whole structure of the fold reinforcing unit 50. The fold reinforcing unit 50 includes a fold reinforcing roller unit 60 (hereinafter, simply referred to as a roller unit 60), a support section 70 and a drive unit 80.

The roller unit 60 includes the fold reinforcing roller pair 51. The fold reinforcing roller pair 51 nips and presses the fold line of the sheet bundle pushed out of the upstream fold roller pair 38, and moves along the fold line to reinforce the fold line.

The support section 70 supports the roller unit 60 so that the roller unit 60 can slide in the fold line direction, and includes a nipping member of the sheet bundle, a structural member of the whole fold reinforcing unit 50, and the like.

The drive unit 80 includes a drive motor 81, and drives the roller unit 60 along the fold line by the drive motor 81.

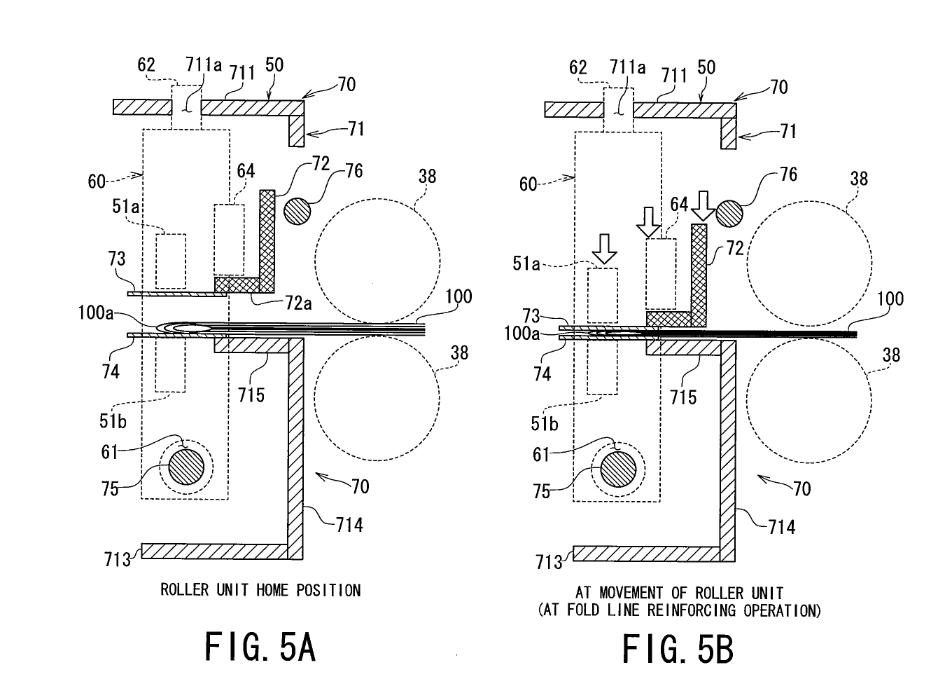

Among the roller unit 60, the support section 70 and the drive unit 80, the structure of the support section 70 will be firstly described with reference to FIG. 4 and FIGS. 5A and 5B. FIGS. 5A and 5B are schematic sectional views for mainly illustrating the structure of the support section 70. FIG. 5A is a sectional view when the roller unit 60 is at a home position (standby position: left end position in FIG. 4), and FIG. 5B is a sectional view when the roller unit 60 is moving (the fold line is reinforced).

The support section 70 includes a frame 71, and the frame 71 includes a top plate 711, right and left side plates 712a and 712b, a bottom plate 713, a back plate 714, a sheet bundle placement table 715 (see FIGS. 5A and 5B, etc.) and the like.

The top plate 711 is provided with a support hole 711a extending in its longitudinal direction.

Further, a support shaft 75 which supports the roller unit 60, a transport guide 72 having an L-shaped section, a drive shaft 76 (see FIG. 5A and FIG. 5B, etc.) which drives the transport guide 72 in the up-and-down direction, and the like are provided between both the side plates 712a and 712b.

A band-like flexible member 73 formed of a film-like resin member of polyethylene terephthalate (PET) or the like is extended from a bottom plate 72a of the transport guide 72. A similar flexible member 74 is extended also from the sheet placement table 715.

As shown in FIGS. 5A and 5B, a fold line 100a of a sheet bundle 100 is nipped between the flexible members 73 and 74, and is pressed by the fold reinforcing roller pair 51 (the upper roller 51a and the lower roller 51b) through the flexible members 73 and 74, and thus the fold line is reinforced. The occurrence of a scratch or a wrinkle in the fold line and in the vicinity thereof is prevented through the flexible members 73 and 74.

Cut sections 73a and 74b are provided at leading edges of the flexible members 73 and 74. These cut sections 73a and 74b are provided at positions corresponding to positions of staples of the fold line, and prevent the flexible members 73 and 74 from being damaged by the staples.

A through hole 61 through which the support shaft 75 passes is provided in a lower part of the roller unit 60. Further, a support roller 62 for keeping the attitude is provided in an upper part of the roller unit 60, and the support roller 62 is moved along the support hole 711a provided in the top plate 711.

The position (except for a position change in the movement direction) of the roller unit 60 and the three-axial attitude are regulated by the support shaft 75 and the through hole 61, and the support hole 711a and the support roller 62, and are kept constant also during the movement of the roller unit 60.

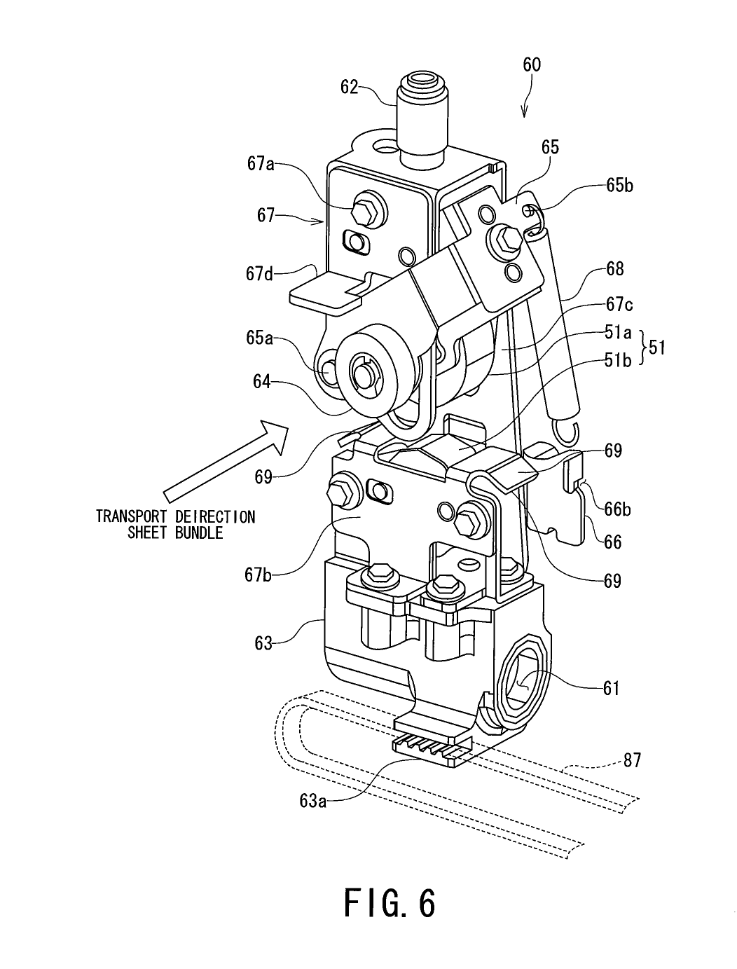

Next, the structure of the roller unit 60 will be described. FIG. 6 is a perspective outer appearance view showing a structural example of the roller unit 60, and is a view seen from a sending source side of the sheet bundle (direction opposite to FIG. 4).

The roller unit 60 is a unit which is provided therein with the fold reinforcing roller pair 51, and includes a unit support section 63 that is positioned at a lower part thereof and is provided with the through hole 61, and a unit frame 67 fixed to an upper part of the unit support section 63.

In the unit frame 67, an upper frame 67a having a hollow section and a lower frame 67b having a similar hollow section are fixed and coupled by a frame plate 67c.

Further, the roller unit 60 includes an upper link member 65 and a lower link member 66, and both the members 65 and 66 are spring-coupled by a spring 68. One end of the spring 68 is engaged with a hook hole 65b of the upper link member 65, and the other end of the spring 68 is engaged with a cut part 66b of the lower link member 66. FIG. 6 shows the spring 68 in a free state in which the other end of the spring 68 is released from the cut part 66b, but in a state where the other end of the spring 68 is actually engaged with the cut part 66b, a tensile force of the spring 68 is applied between the upper link member 65 and the lower link member 66.

The lower roller 51b which is one of the fold reinforcing roller pair 51 is accommodated in the hollow section of the lower frame 67b. The lower roller 51b is supported around a lower roller shaft (not shown) fixed to the lower frame 67b to be able to rotate.

Further, the lower link member 66 is coupled to the side of the lower frame 67b through a lower link shaft 66a (see FIG. 4) fixed to the lower frame 67b to be able to rotate.

The upper roller 51a which is one of the reinforcing roller pair 51 is accommodated in the hollow section of the upper frame 67a. The upper roller 51a is supported around an upper roller shaft (not shown) fixed to the upper link member 65 (not the upper frame 67a) to be able to rotate.

The rotation shaft (lower roller shaft) of the lower roller 51b is fixed to the lower frame 67b (that is, fixed to the unit frame 67), and even if the roller unit 60 is moved, the position of the lower roller 51b is not changed in the up-and-down direction. The position of the upper end of the lower roller 51b is adjusted to be the same as the position of the flexible member 74. When the roller unit 60 is moved, the lower roller 51b is rotated while coming in contact with the lower surface of the flexible member 74.

On the other hand, the upper roller shaft of the upper roller 51a is fixed to the upper link member 65. When the roller unit 60 starts to move away from the home position, the upper link member 65 is pulled by the spring 68, and starts to rotate downward around a upper link shaft 65a. By this rotation, the upper roller 51a rotatably attached to the upper link member 65 starts to descend, and is moved to a position where the upper roller 51a comes in contact with the lower roller 51b. The pressing force caused by the tensile force of the spring 68 is mutually exerted between the upper roller 51a and the lower roller 51b. Actually, since the sheet bundle is nipped between the upper roller 51a and the lower roller 51b through the flexible members 73 and 74, the fold line of the sheet bundle is reinforced by the pressing force between the upper roller 51a and the lower roller 51b.

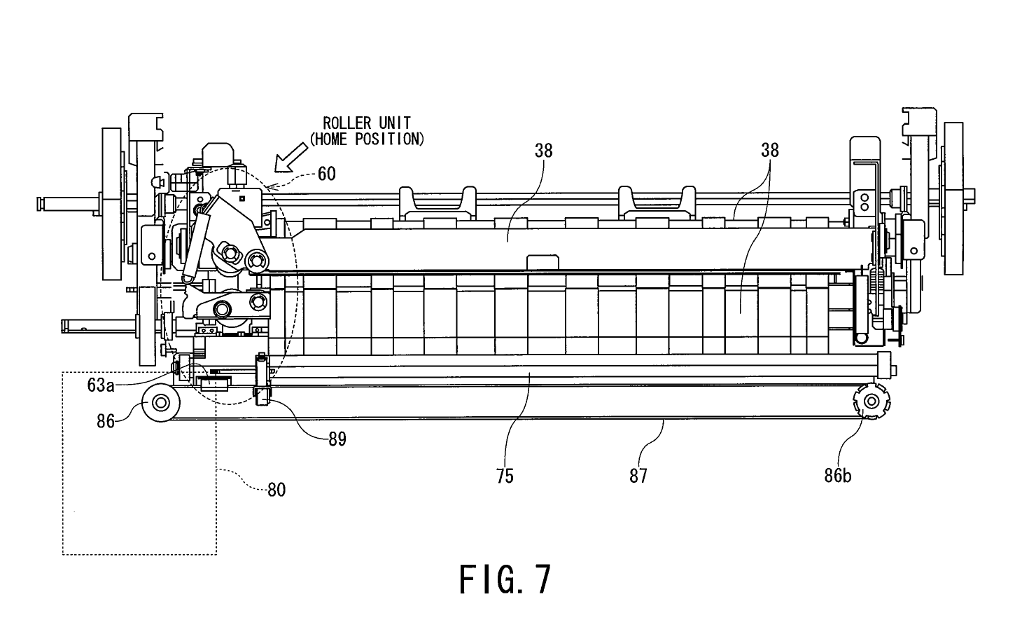

FIG. 7 is a diagram illustrating a position relationship of the drive unit 80. FIG. 7 is a view when seen from a transport destination of the sheet bundle to a transport source thereof, and also shows the roller unit 60 at the home position, the fold roller pair 38 and the drive mechanism of the fold roller pair 38. The illustration of the structural member of the support section 70 is partially omitted for convenience of explanation.

The drive unit 80 includes a drive motor 81 and a gear train which will be described in a portion surrounded by a broken line in FIG. 7. The drive motor 81 is a DC motor, and the rotation direction and speed thereof can be controlled from the outside.

The drive force of the drive motor 81 is transmitted to a driving gear pulley 86a through the gear train. On the other hand, a unit drive belt 87 is stretched between the driving gear pulley 86a and a driven pulley 86b. The unit drive belt 87 is moved between the driving gear pulley 86a and the driven pulley 86b by the drive force of the drive motor 81.

A rack is formed on the surface of the unit drive belt 87, and the rack is engaged with teeth of a fit section 63a (see FIG. 6) provided at the lower part of the roller unit 60, so that the roller unit 60 can be reliably moved without sliding in the fold line direction. The movement direction of the unit drive belt 87 can be changed by reversing the rotation direction of the drive motor 81, and thus the roller unit 60 can be reciprocated.

In the fold reinforcing unit 50, the upper roller 51a moves up and down inside the roller unit 60 and the transport guide 72 moves up and down, in addition to the movement of the roller unit 60 in the fold line direction. The drive source of the up and down movements of these elements is the drive motor 81. That is, the drive operation of the fold reinforcing unit 50 is carried out by the single drive motor 81.

FIG. 7 shows a home position sensor 89 which detects that the roller unit 60 moves away from the home position or the roller unit 60 returns to the home position.

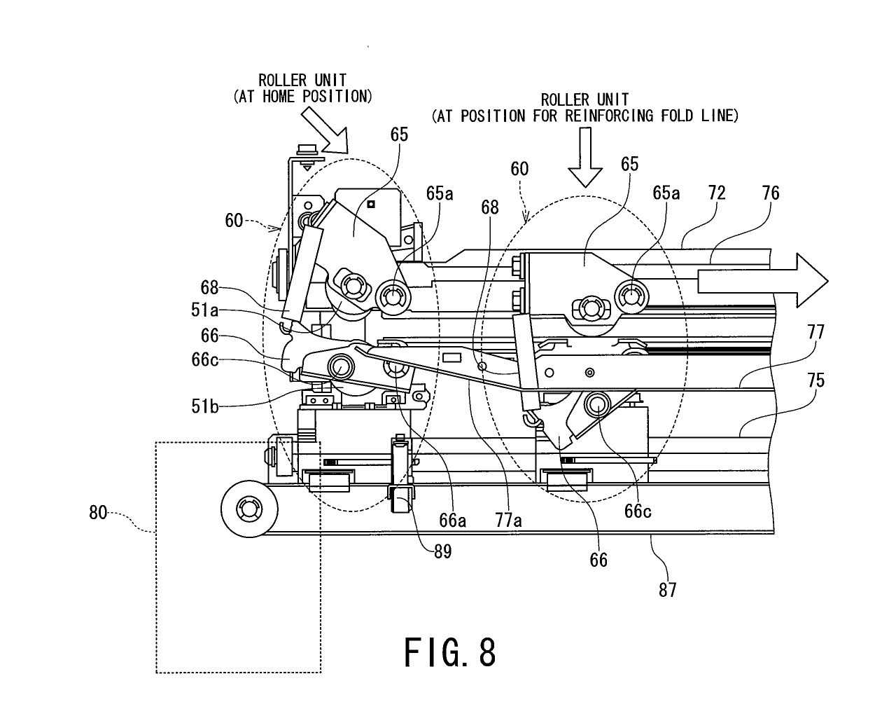

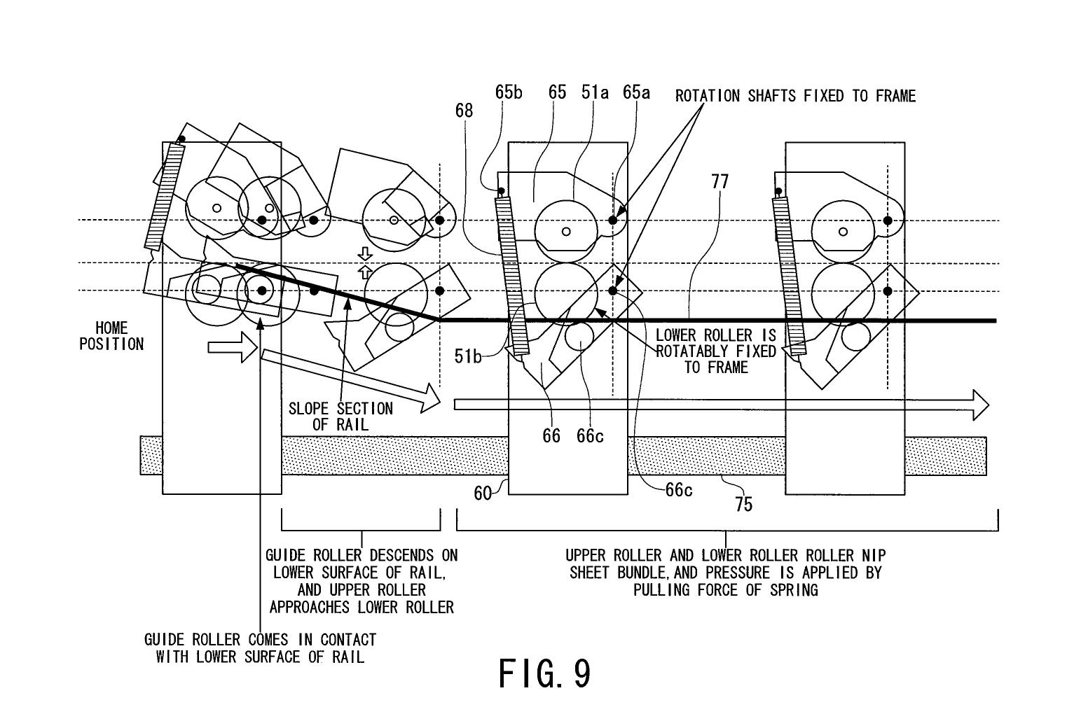

FIGS. 8 and 9 are views illustrating the mechanism of the up-and-down drive of the upper roller 51a. As described above, the upper link member 65 and the lower link member 66 of the roller unit 60 are spring-coupled by the spring 68 at the positions farthest from the respective rotation shafts (the upper and lower link shafts 65a and 66a). Further, the lower link member 66 is provided with a freely rotating guide roller 66c (see FIG. 4, etc.).

On the other hand, as shown in FIGS. 8 and 9, the support section 70 includes a guide rail 77 having an L-shaped section. The guide rail 77 has a slope section 77a in the vicinity of the home position, and is parallel to the fold line direction of the sheet bundle, (i.e., horizontal) except for the slope section 77a.

When the roller unit 60 is driven by the drive belt 87 and moves away from the home position, as shown in FIG. 9, the guide roller 66c comes in contact with the bottom of the slope section 77a of the guide rail 77 before long. Thereafter, the guide roller 66c descends along the bottom of the slope section 77a. As the guide roller 66c descends, the lower link member 66 is rotated around the lower link shaft 66a in the counterclockwise direction in FIG. 9. Further, the upper link member 65 is also pulled by the spring 68 and is rotated around the upper link shaft 65a in the counterclockwise direction. As a result, the upper roller 51a between the upper link shaft 65a and the hook hole 65b of the spring 68 gradually descends while the roller unit 60 moves on the slope section 77a, and the interval between the upper roller 51a and the lower roller 51b is gradually shortened. Then, the upper roller 51a and the lower roller 51b come in contact with each other in the vicinity of an area where the slope section 77a is terminated. At this time, a pressure (pressing force) to press each other is exerted between the upper roller 51a and the lower roller 51b. The pressing force is based on the tensile force of the spring 68.

In a horizontal area (that is, the effective drive area) of the guide rail 77, the upper roller 51a and the lower roller 51b apply the pressure to the fold line of the sheet bundle while keeping the pressing force to thereby reinforce the fold line.

### (3) Driving of Fold Reinforcing Roller

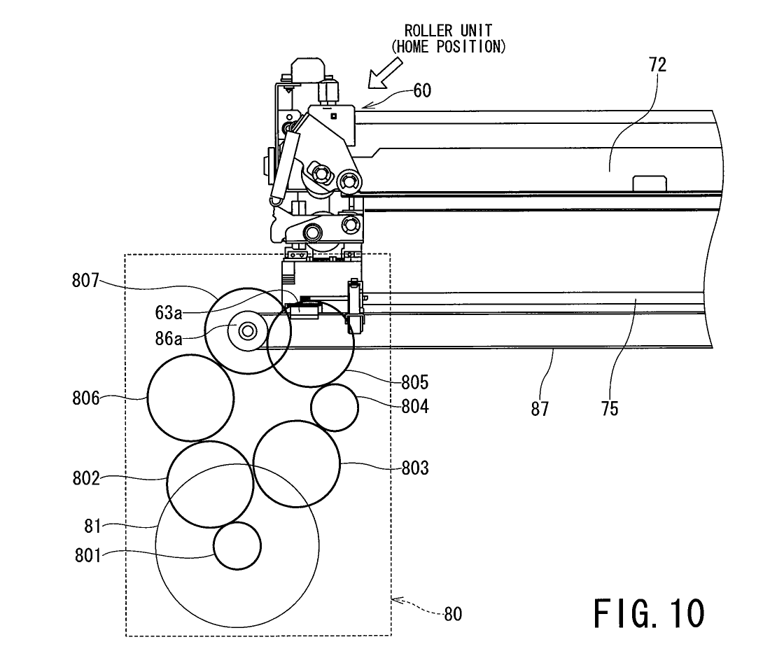

FIG. 10 is a diagram showing a detailed configuration example of the drive unit 80. As described above, the drive unit 80 includes the drive motor 81 and the gear train. The rotational drive force of the drive motor 81 is transmitted to the driving gear pulley 86a through the gear train. Thus, the unit drive belt 87 is moved in the horizontal direction by rotation of the driving gear pulley 86a, and the roller unit 60 fixed to the unit drive belt 87 through the fit section 63a is also moved in the horizontal direction. When the roller unit 60 starts to horizontally move away from the home position, the upper roller 51a descends toward the lower roller 51b and nips the fold line of the sheet bundle. Thereafter, the fold reinforcing roller pair 51 (upper roller 51a and lower roller 51b) moves in the horizontal direction while pressing the fold line to reinforce the fold line.

The gear train includes a plurality of gears which forms two paths of a transmission path A and a transmission path B. The transmission path A includes a gear train having a shaft gear 801 of the drive motor 81, a gear 802, a gear 803 (electromagnetic clutch A), a gear 804 and a gear 805. On the other hand, the transmission path B includes a gear train having the shaft gear 801 of the drive motor 81, the gear 802, a gear 806 and a gear 807 (electromagnetic clutch B). The gear 803 and the gear 807 are formed as the electromagnetic clutches. When each electromagnetic clutch is turned on, the rotation is transmitted, and when the electromagnetic clutch is turned off, the rotation transmission is cut off.

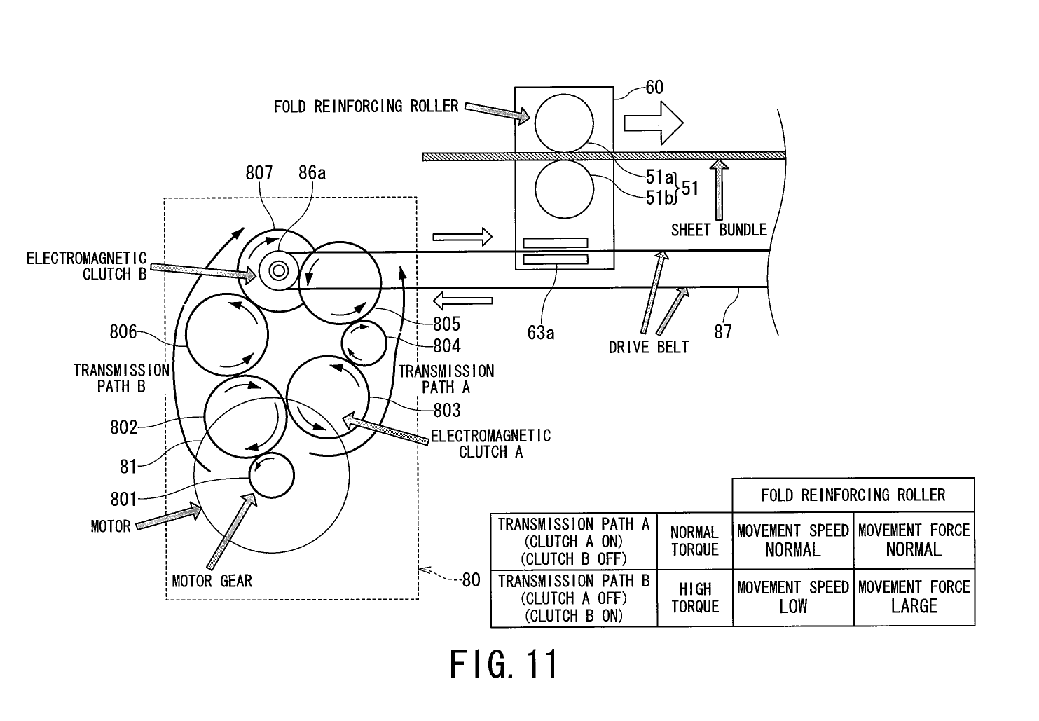

FIG. 11 is a diagram schematically illustrating the relationship between ON and OFF of the electromagnetic clutches A and B and selection of the transmission paths, and the like. When the electromagnetic clutch A is turned on and the electromagnetic clutch B is turned off, the transmission path A is selected. Contrarily, when the electromagnetic clutch A is turned off and the electromagnetic clutch B is turned on, the transmission path B is selected. Here, a drive torque of the transmission path B is set to be larger than a drive torque of the transmission path A. A specific method of setting different drive torques according to the transmission paths is not limitative. For example, if gear diameters and gear pitches of the gear 802, the gear 803, the gear 805, the gear 806 and the gear 807 are all the same, a torque ratio Ta/Tb becomes a ratio ra/rb of a radius ra of the driving gear pulley 86a to a radius rb of the gear 807 (rb>ra). Here, Ta (this torque is referred to as a normal torque) is a driving torque of the driving gear pulley 86a when the transmission path A is selected, and Tb is to a driving torque of the driving gear pulley 86a when the transmission path B is selected. Accordingly, in the example shown in FIG. 11, the drive torque transmitted to the driving gear pulley 86a when the transmission path B is selected becomes larger than that when the transmission path A is selected. Meanwhile, the rotation speed of the driving gear pulley 86a when the transmission path B is selected becomes slower than that when the transmission path A is selected.

Note that unit drive belt 87 is engaged with the driving gear pulley 86a, and the fold reinforcing roller pair 51 moves with the unit drive belt 87. Thus, the force by which the fold reinforcing roller pair 51 is moved is proportional to the drive torque of the driving gear pulley 86a. Accordingly, the force by which the fold reinforcing roller pair 51 is moved becomes relatively strong when the transmission path B is selected, although the movement speed of the fold reinforcing roller pair 51 becomes relatively slow when the transmission path B is selected.

The sheet finisher 20 according to the present embodiment switches the transmission path of the rotation of the drive motor 81 to change the drive torque of the driving gear pulley 86a, and thus to change the force by which the fold reinforcing roller pair 51 is moved.

Specifically, the sheet finisher 20 drives the fold reinforcing roller pair 51 at a normal torque and a normal speed during a normal operation. On the other hand, when the sheet jam occurs, the sheet finisher 20 drives the driving gear pulley 86a with a large torque to move the fold reinforcing roller pair 51 with stronger power, while decreasing the movement speed of the fold reinforcing rollers 51 to some extent. As a result, even when a large load is applied to the fold reinforcing rollers 51 due to the sheet jam and the fold reinforcing roller pair 51 is stopped, the sheet finisher 20 changes the transmission path so that the drive torque becomes large, and thus, it is possible to climb over a portion where the sheet jam occurs to further go on.

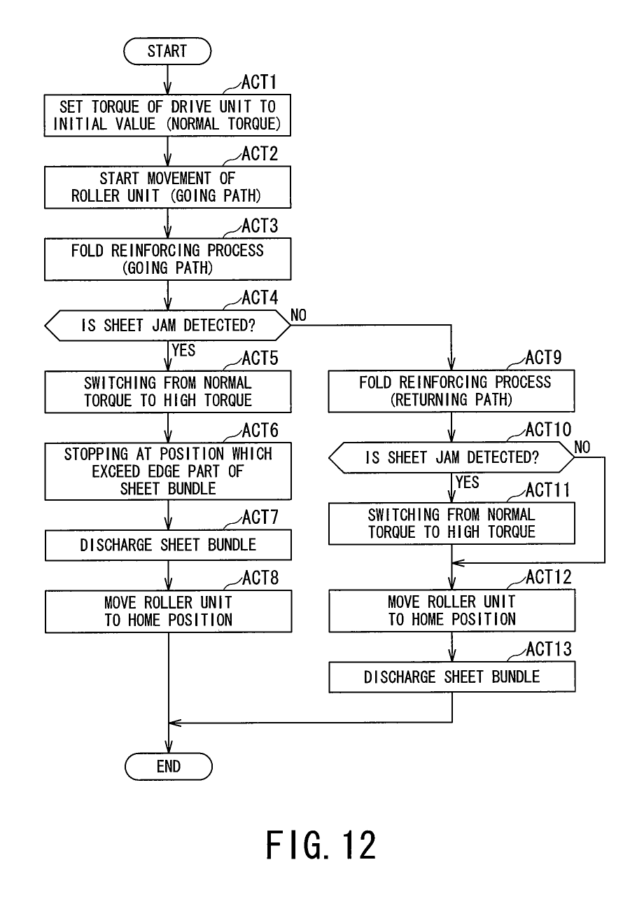

FIG. 12 is a flowchart illustrating an example of an operation of the sheet finisher 20 according to the present embodiment when the sheet jam occurs.

In ACT 1, the torque of the drive unit 80 is set to an initial value (normal torque). In the example shown in FIG. 11, the transmission path A is selected by turning on the electromagnetic clutch A and by turning off the electromagnetic clutch B, and thus the torque transmitted to the driving gear pulley 86a is set to the normal torque.

In ACT 2, the roller unit 60 (fold reinforcing roller pair 51) starts to move in a going path direction. In ACT 3, the fold reinforcing process of a going path is performed, and the presence or absence of the sheet jam is detected (ACT 4).

A specific method of detecting the sheet jam occurrence is not limitative, but for example, when time elapsed after the roller unit 60 moves away from the home position exceeds a predetermined threshold, it is determined that the roller unit 60 stops in the middle thereof, that is, that the sheet jam occurs. In the normal fold reinforcing process operation without the sheet jam occurrence, the roller unit 60 is reciprocated along the fold line. Accordingly, when the roller unit 60 moves away from the home position and does not return to the home position within a predetermined elapse time, it can be considered that the roller unit 60 is stopped in the middle due to the sheet jam occurrence. The fact that the roller unit 60 moves away from the home position or returns to the home position can be detected by the home position sensor 89 shown in FIG. 7 or the like.

Instead, the sheet jam may be detected using the transport time of the sheet bundle. The sheet bundle on which the fold line is to be formed by the fold rollers 38 is temporarily stopped when the fold line reaches the position of the fold reinforcing roller pair 51, and the fold reinforcing process is performed there. When the fold reinforcing process is completed, the sheet bundle starts to move again in the transport direction, is pulled by the discharge roller pair 39, and then is discharged to the sheet bundle placement section 40. Thus, for example, sensors for detecting passage of the sheet bundle may be respectively provided on the outlet side of the fold rollers 38 and on the front side of the discharge roller pair 39, and time points when the leading edge of the sheet bundle passes therethrough may be respectively measured using the two sensors. Consequently, when a difference between the time points, that is, the transport time of the sheet bundle is longer than a predetermined time, it may be determined that the sheet jam occurs during the fold reinforcing process.

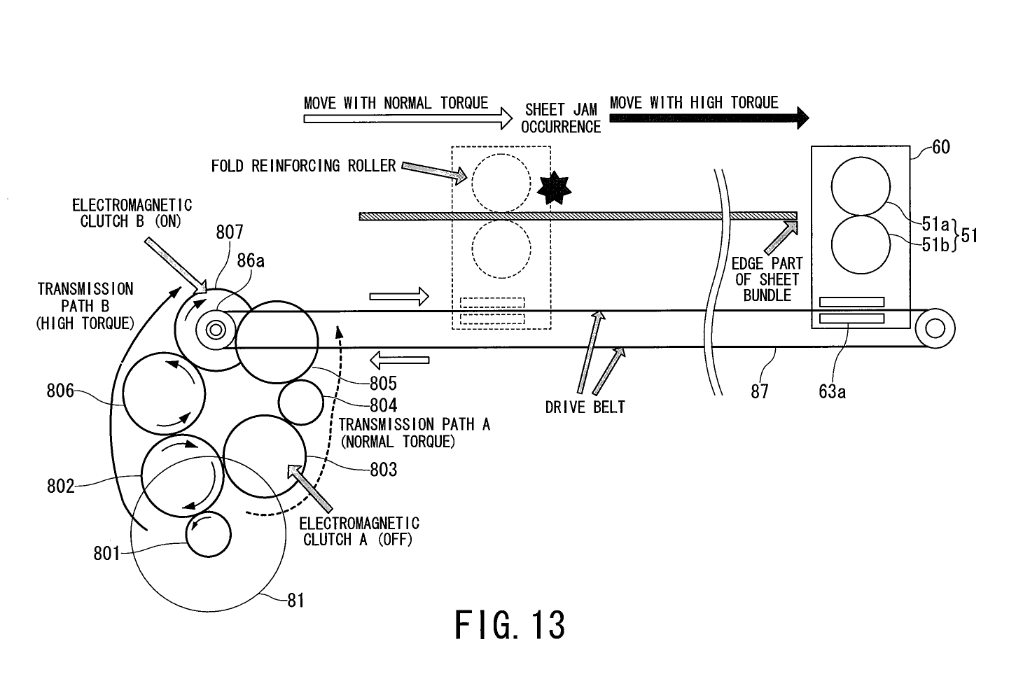

If it is determined that the sheet jam is detected in ACT 4, the torque of the drive unit 80 is switched from the normal torque to a high torque, in ACT 5. Specifically, as shown in FIG. 13, the electromagnetic clutch A is turned off and the electromagnetic clutch B is turned on, and thus the transport path A is switched into the transport path B. As a result, the torque transmitted to the driving gear pulley 86a is switched from the normal torque to the high torque. Through this switching, the roller unit 60 can move with a force stronger than that at the normal torque, and can overcome the sheet jam occurrence portion to further go on.

Then, as shown in an upper right section of FIG. 13, the fold reinforcing roller pair 51 is stopped in a position which exceeds the edge part of the sheet bundle (ACT 6). That is, the roller unit 60 proceeds up to a position which does not obstruct discharge of the sheet bundle, and then stops there.

In ACT 7, the sheet bundle is pushed out by the fold rollers 38, and is then discharged to the sheet bundle placement section 40 by being pulled by the discharge roller pair 39.

Further, after the sheet bundle is discharged, the roller unit 60 is moved to the home position (ACT 8).

On the other hand, if the sheet jam does not occur in the fold reinforcing process of the going path (NO in ACT 4), a fold reinforcing process of a returning path is performed (ACT 9).

Further, if the sheet jam occurs during the fold reinforcing process of the returning path (YES in ACT 10), in a similar way to ACT 5, the normal torque is switched to the high torque to overcome the sheet jam occurrence portion (ACT 11). After overcoming the sheet jam occurrence portion, the roller unit 60 returns to the home position.

If the sheet jam does not occur in the fold reinforcing process of the returning path (NO in ACT 10), the roller unit 60 also returns to the home position (ACT 12).

After the roller unit 60 returns to the home position, the sheet bundle is discharged.

According to the sheet finisher 20 according to the above-described embodiment, when the sheet jam occurs, it is possible to automatically switch the force (drive torque), which drives the roller unit 60, to the drive torque which is larger than the normal torque. As a result, the fold reinforcing roller pair 51 which is temporarily stopped due to the sheet jam can overcome the sheet jam occurrence portion to further go on, to thereby prevent the image forming apparatus from being temporarily stopped. Further, a user does not have to perform a repairing operation of pulling the sheet bundle which is stopped in the state of being nipped in the fold reinforcing roller pair 51 by hand.

### (4) Other Embodiments

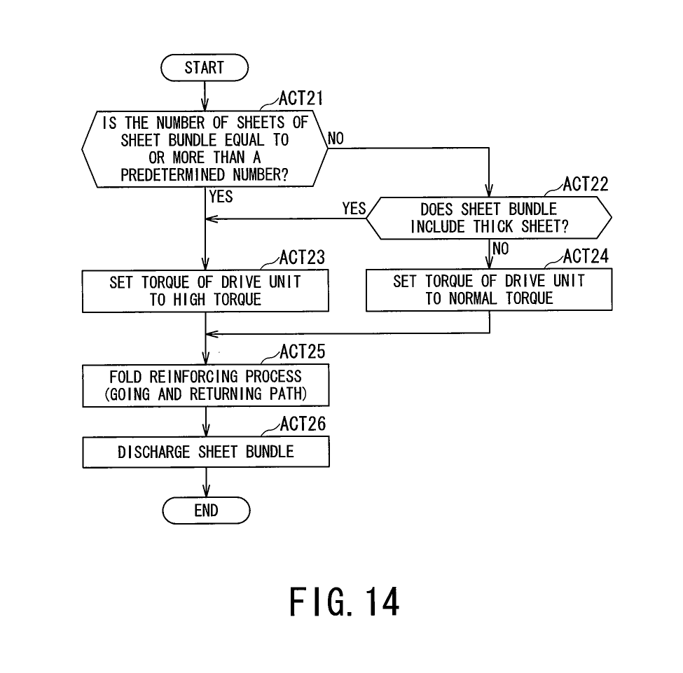

FIG. 14 is a flowchart illustrating an operation example of the sheet finisher 200 according to another embodiment. In this embodiment, torque switching of the drive unit 80 is performed according to the number of sheets which forms the sheet bundle or whether a thick sheet which is equal to or thicker than a predetermined thickness is included in the sheet bundle.

In ACT 21, it is determined whether the number of sheets of the sheet bundle is equal to or more than a predetermined number. For example, it is determined whether the number of sheets which forms the sheet bundle is 15 or more. If the number of sheets is equal to more than the predetermined number, in ACT 23, the torque of the drive unit 80 is set to a high torque. The high torque setting is the same as in the above-described method. That is, the transmission path A is switched to the transmission path B by turning off the electromagnetic clutch A and by turning on the electromagnetic clutch B, and the torque transmitted to the driving gear pulley 86a is switched from the normal torque to the high torque.

Further, in ACT 22, it is determined whether the thick sheet is included in the sheet bundle. Even when the number of sheets is less than the predetermined number, if the thick sheet is included in the sheet bundle (YES in ACT 22), the torque of the drive unit 80 is set to the high torque.

On the other hand, if the number of sheets of the sheet bundle is less than the predetermined number and the thick sheet is not included (NO in ACT 22), the torque of the drive unit 80 is set to the normal torque. That is, the transmission path A is selected by turning on the electromagnetic clutch A and by turning off the electromagnetic clutch B, and the torque transmitted to the driving gear pulley 86a is set to the normal torque.

In the flowchart shown in FIG. 14, the sheet number determination and the thick sheet presence or absence determination are all performed, but only one determination may be performed.

The number of sheets or the presence or absence of the thick sheet may be determined using information set by a user through the operation unit 9 of the image forming unit 12, or may be determined using information on the number of sheets counted inside the image forming unit 12 or information on the sheet thickness detected inside the image forming unit 12.

In ACT 25, the fold reinforcing process of the sheet bundle is performed by reciprocating the fold reinforcing roller pair 51 according to the normal operation. Then, the sheet bundle on which the fold line is reinforced is discharged in ACT 26.

Generally, it may be difficult to obtain a reliable fold line for the sheet bundle having a large number of sheets or the sheet bundle including a thick sheet, even though the fold reinforcing process is performed by the fold reinforcing roller pair 51. However, in this embodiment, since the fold reinforcing roller pair 51 can be driven with a high torque with respect to the sheet bundle having the large number of sheets or the sheet bundle including the thick sheet, it is possible to form a reliable fold line compared with that of the related art.

By suitably combining a plurality of components disclosed in the embodiments, a variety of embodiments can be made. For example, some components may be omitted from all the components disclosed in the embodiment. Further, components included in different embodiments may be suitably combined.

What is claimed is:

1. A sheet finisher comprising:
a fold roller which folds a central area of a sheet bundle to form a fold line on the sheet bundle;
a fold reinforcing roller which moves along a direction of the fold line while pressing the fold line of the sheet bundle to reinforce the fold line; and
a drive unit which includes a motor and transmits a drive torque of the motor to the fold reinforcing roller, so that the drive torque can be changed, to move the fold reinforcing roller along the fold line.

2. The sheet finisher according to claim 1,
wherein the drive unit includes a first gear train which transmits rotation of the motor to the fold reinforcing roller and a second gear train which is installed in parallel with the first gear train and transmits the rotation of the motor to the fold reinforcing roller with a drive torque larger than that of the first gear train, and
wherein the drive torque is changed by selectively switching the first gear train and the second gear train.

3. The sheet finisher according to claim 2,
wherein a first electromagnetic clutch and a second electromagnetic clutch are respectively installed to the first gear train and the second gear train, and
wherein the first gear train and the second gear train are selectively switched by performing setting so that the second electromagnetic clutch is turned off when the first electromagnetic clutch is turned on, and the second electromagnetic clutch is turned on when the first electromagnetic clutch is turned off.

4. The sheet finisher according to claim 1, further comprising a sheet jam detecting section which detects occurrence of a sheet jam,
wherein if the occurrence of the sheet jam is detected, the drive unit changes the drive torque to be larger than that before the sheet jam detection.

5. The sheet finisher according to claim 4, further comprising a transport section which transports the sheet bundle in a direction orthogonal to the fold line,
wherein after changing the drive torque to be large, the drive unit moves the fold reinforcing roller outside an edge part of the sheet bundle, and
wherein the transport section discharges the sheet bundle to the outside after the fold reinforcing roller moves outside the edge part of the sheet bundle.

6. The sheet finisher according to claim 1,
wherein when the number of sheets which form the sheet bundle is larger than a predetermined threshold, the drive unit changes the drive torque to be larger than that when the number of sheets is equal to or smaller than the predetermined threshold.

7. The sheet finisher according to claim 1,
wherein when a sheet thicker than a standard sheet is included in sheets which form the sheet bundle, the drive unit changes the drive torque to be larger than that when the sheet bundle includes the standard sheets only.

8. The sheet finisher according to claim 1,
wherein the fold reinforcing roller includes a first roller and a second roller, and moves along the fold line direction while pressing the fold line of the sheet bundle between the first roller and the second roller.

9. An image forming apparatus comprising:
a read unit which reads an original document;
an image forming unit which prints image data on the read original document on a sheet by an electro-photographic technique;
a fold roller which folds a central area of a sheet bundle including a plurality of printed sheets to form a fold line on the sheet bundle;
a fold reinforcing roller which moves along a direction of the fold line while pressing the fold line of the sheet bundle to reinforce the fold line; and
a drive unit which includes a motor and transmits a drive torque of the motor to the fold reinforcing roller, so that the drive torque can be changed, to move the fold reinforcing roller along the fold line.

10. The apparatus according to claim 9,
wherein the drive unit includes a first gear train which transmits rotation of the motor to the fold reinforcing roller and a second gear train which is installed in parallel with the first gear train and transmits the rotation of the motor to the fold reinforcing roller with a drive torque larger than that of the first gear train, and
wherein the drive torque is changed by selectively switching the first gear train and the second gear train.

11. The apparatus according to claim 10,
wherein a first electromagnetic clutch and a second electromagnetic clutch are respectively installed to the first gear train and the second gear train, and
wherein the first gear train and the second gear train are selectively switched by performing setting so that the second electromagnetic clutch is turned off when the first electromagnetic clutch is turned on, and the second electromagnetic clutch is turned on when the first electromagnetic clutch is turned off.

12. The apparatus according to claim 9, further comprising a sheet jam detecting section which detects occurrence of a sheet jam,
wherein if the occurrence of the sheet jam is detected, the drive unit changes the drive torque to be larger than that before the sheet jam detection.

13. The apparatus according to claim 12, further comprising a transport section which transports the sheet bundle in a direction orthogonal to the fold line,
wherein after changing the drive torque to be large, the drive unit moves the fold reinforcing roller outside an edge part of the sheet bundle, and
wherein the transport section discharges the sheet bundle to the outside after the fold reinforcing roller moves outside the edge part of the sheet bundle.

14. The apparatus according to claim 9,
wherein when the number of sheets which form the sheet bundle is larger than a predetermined threshold, the drive unit changes the drive torque to be larger than that when the number of sheets is equal to or smaller than the predetermined threshold.

15. The apparatus according to claim 9,
wherein when a sheet thicker than a standard sheet is included in sheets which form the sheet bundle, the drive unit changes the drive torque to be larger than that when the sheet bundle includes the standard sheets only.

16. The apparatus according to claim 9,
wherein the fold reinforcing roller includes a first roller and a second roller, and moves along the fold line direction while pressing the fold line of the sheet bundle between the first roller and the second roller.

17. A sheet finishing method, comprising:
folding a central area of a sheet bundle to form a fold line on the sheet bundle, by a fold roller;
moving a fold reinforcing roller along a direction of the fold line while pressing the fold line of the sheet bundle to reinforce the fold line; and
transmitting a drive torque of a motor to the fold reinforcing roller, so that the drive torque can be changed, to move the fold reinforcing roller along the fold line.

18. The method according to claim 17,
wherein a first gear train which transmits rotation of the motor to the fold reinforcing roller and a second gear train which is installed in parallel with the first gear train and transmits the rotation of the motor to the fold reinforcing roller with a drive torque larger than that of the first gear train are selectively switched to change the drive torque.

19. The method according to claim 18,
wherein a first electromagnetic clutch and a second electromagnetic clutch are respectively installed to the first gear train and the second gear train, and
wherein the first gear train and the second gear train are selectively switched by performing setting so that the second electromagnetic clutch is turned off when the first electromagnetic clutch is turned on, and the second electromagnetic clutch is turned on when the first electromagnetic clutch is turned off.

20. The method according to claim 17, further comprising detecting occurrence of a sheet jam,
wherein if the occurrence of the sheet jam is detected, the drive torque is changed to be larger than that before the sheet jam detection.
